(19) United States
(12) Patent Application Publication
(10) Pub. No.: US 2016/0044071 A1
(43) Pub. Date: Feb. 11, 2016

(54) SHARING A WEB BROWSER SESSION BETWEEN DEVICES IN A SOCIAL GROUP

(71) Applicant: Hewlett-Packard Development Company, L.P., Houston, TX (US)

(72) Inventor: Thomas E. Sandholm, Palo Alto, CA (US)

(21) Appl. No.: 14/781,767

(22) PCT Filed: Apr. 2, 2013
(86) PCT No.: PCT/US2013/035008

§ 371 Date: Oct. 1, 2015

(51) Int. Cl. H04L 29/06; H04L 12/58; H04L 29/08

(52) U.S. Cl. CPC H04L 65/403; H04L 67/02; H04L 51/32

(57) ABSTRACT

A content sharing platform for sharing a web browser session between users in a social group is disclosed. The content sharing platform enables users of mobile devices to share a reference to the social group between users in the social group. A web sharing session is initiated by running a bookmarklet on a web page accessed by a primary user in the social group. Content from the web page and an action of the primary user on the web page are encoded into an image. The encoded image is associated with the reference to the social group and presented on a web page to one or more secondary users in the social group.

### CROSS-REFERENCE TO RELATED APPLICATIONS

This application is related to PCT Patent Application Serial No. PCT/US2012/057438 (Attorney Docket No. 83011257), entitled “Sharing Content Between Collocated Mobile Devices in an Ad-Hoc Private Social Group”, filed on Sep. 27, 2012, assigned to the assignee of the present application and incorporated by reference herein.

### BACKGROUND

The proliferation of the Internet has facilitated the sharing and distribution of content like never before. Users now flock to websites, search engines, and social networks to access and share content from multiple devices and locations around the world. The devices may include personal and portable computers, phones, tablets, video game consoles, personal digital assistants, smart TVs, or an device configured to access the Internet. The access may be wired or wireless, with wireless access growing much faster. It is predicted that by 2016 there will be more wireless devices than people in the world.

Along with the rise in popularity of wireless devices, there has been a growing demand for content sharing platforms that are targeted specifically for the mobile user. These include, for example, Instagram for sharing photos, Foursquare for sharing location information, Facebook Mobile and Google+ Mobile for sharing content with friends, Twitter Mobile for sharing short messages, and Google Does Mobile for sharing documents, among others. These content sharing platforms enable users to easily share content among their social network peers. However, they are not optimized to let users share and interact with content instantly and securely in real-time in social groups in arbitrary devices.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates a schematic diagram of an environment where the content sharing platform is used in accordance with various examples;

FIG. 2 illustrates a flowchart for sharing a web browser session between users in a social group;

FIG. 3 illustrates a schematic diagram of a content sharing platform architecture in accordance with various examples;

FIG. 4 illustrates a cross-platform web user interface for sharing a web browser session with the content sharing platform of FIG. 3 according to various examples;

FIG. 5 illustrates a user interface window displayed to a secondary user showing the web page shared by a primary user in FIG. 4;

FIGS. 6 illustrates a user interface window displayed when a primary user clicks on a link on the web page shown in FIG. 4;

FIG. 7 illustrates a user interface window displayed to a secondary user showing the web page shared by a primary user in FIG. 6;

FIG. 8 illustrates a user interface window displayed to a secondary user when the secondary user clicks on a link on the web page shown in FIG. 7;

FIG. 9 illustrates a user interface window displayed to a primary user showing the web page shared by the secondary user in FIGS. 8; and

FIG. 10 illustrates a block diagram of an example computing system for hosting the modules of FIG. 3 according to various examples.

### DETAILED DESCRIPTION

A content sharing platform for sharing a web browser session between users in a social group is disclosed. The content sharing platform enables users in a social group to share, collaborate, and interact with web pages seamlessly across mobile devices in real-time. The mobile devices may be physically collocated in a physical venue such as, for example, a conference or meeting room, or located remotely. The social group may be formed by invitation or by automatically discovering the users' location.

In various examples, the content sharing platform may be accessed from a web page without any plug-ins and across any number of devices, operating systems, and browsers. The content sharing platform may also support numerous form factors, all the way from big projector screens down to small screen sizes in mobile phones. Users of the content sharing platform may share, interact and collaborate with web pages in real-time.

As described in more detail herein below, a primary user can initiate a web sharing session by running a bookmarklet on a target web page that the primary user desires to share with other users (referred herein as secondary users) in the social group. The content sharing platform allows the secondary users to see the same web page on their devices that the primary user is accessing by presenting the web page as an image on their devices. The content sharing platform also allows the secondary users to see the actions the primary user is performing on the web page (e.g., clicking on a link, changing mouse positions on the page, etc.), and conversely, the primary user can see the actions performed by the secondary users on the web pages rendered as images on their devices.

The content sharing platform therefore enables two-way sharing of web pages and actions on the web pages by users in a social group. Any user in the social group can control a web page viewed by another user at any given time. As generally referred to herein, a primary user is a user who initiates a web sharing session with other users in the social group, referred to as the secondary users. Both the primary user and the secondary users can view and control their actions on the web pages shared in their devices.

As described in more detail below, the content sharing platform has four main modules: (1) a cross platform web interface module to enable users to share, interact and collaborate with content in a social group; (2) a bookmarklet module to track actions of a user on a web page and encode content from the web page and the actions of the user on the web page into an image; (3) a real-time messaging module to process events and messages front the bookmarklet module; and (4) a content sharing module to associate the encoded image with a reference to the social group and present the encoded image on a web page to one or more secondary users in the social group.

It is appreciated that, in the following description, numerous specific details are set forth to provide a thorough understanding of various examples. However, it is appreciated that the examples may be practiced without limitation to these specific details. In other instances, well known methods and structures may not be described in detail to avoid unnecessarily obscuring the description of the examples. Also, the examples may be used in combination with each other.

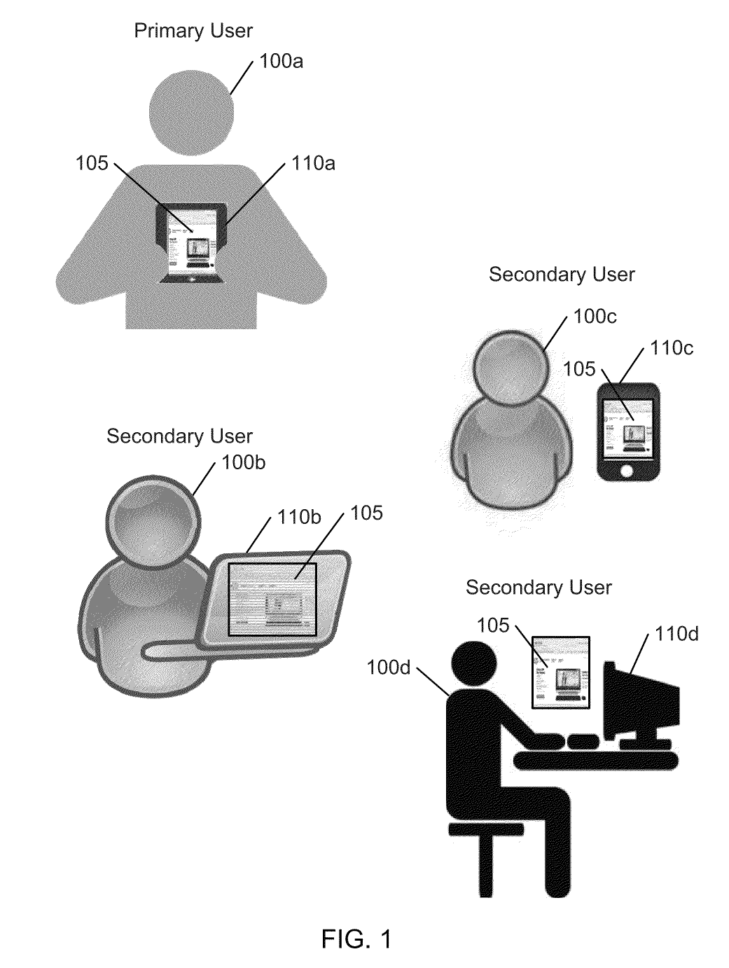

Referring now to FIG. 1, a schematic diagram of an environment where the content sharing platform is used in accordance with various examples is described. Users 100a-d would like to share, interact, and collaborate with web pages viewed in their mobile devices. More specifically, users 100a-d would like to have a collaborative web sharing session in which a web page is shared between them and the actions performed on the web page by any given user 100a-d is seen by the other users. As an example, suppose user 100a would like to share a web page 105 with the other users 100b-d and show them how to navigate the web page 105 (e.g., in a training scenario where user 100a has to train users 100b-d on how to use the various functions on the page, in a publishing scenario where user 100a is showing users 100b-d how the content on the web page will look like, and so on). In doing so, user 100a would like for users 100b-d to see exactly the same web page that the user 100a is seeing, regardless of their devices.

User 100a may be accessing the web on a tablet 110a, user 100b may be accessing the web on a laptop 100b, user 100c may be accessing the web on a smartphone 110c, and user 100d may be accessing the web on a desktop 110d. Each one of the devices 110a-d may render web pages differently, depending on their network connections, screen sizes, and so on. If user 100a resizes the page, a smaller page is sent to users 100b-d. Only the visible part of the web page viewed by user 100a is shared with users 100b-d, and the web page is automatically cropped as needed. The goal is to maintain WYSIWYG throughout the web sharing session.

User 100a may be referred to as a primary user (since user 100a is initiating the web sharing session), and users 100b-d may be referred to as secondary users (as recipients of the web page 105 shared by user 100a). As described in more detail below, the web page 105 is encoded as an image with a bookmarklet running in the user's 110a web browser. The image is shared on a web page with the users 110b-d, thereby enabling the web page 105 to be viewed the same way across the different devices 110a-d. Each user 110b-d receives a representation of the image that is suitable for display at their devices. In addition, any action performed by the user 100a on the web page 105 (e.g., a change in mouse position or navigation, a click on a link or media file, etc.) can be viewed by the other users 100b-d on their rendered images as if the action was actually performed by them. Likewise, any action performed by a user 100b-d on their rendered images can be viewed and emulated by the other users. For example, if one of the users 100b-d clicks on a button in the encoded image displayed on his/her device, this action will be captured and sent to the user 100a. The action will then be translated into a real action on the web page of the user 100a, i.e., the web page of the user 100a will receive the click event as if the user 100a actually clicked on the button and the web page is updated accordingly. The updated web page is then encoded as an image and the encoded image is sent on a web page to the other users 100b-d so the other users can see the updated image that was a result of the user's 100a action (i.e., a click on a web page button).

In various examples, the users 100a-b share content in a social group that may be formed by invitation or by automatically discovering the users' location (e.g., via GPS or Wi-Fi positioning). The social group is identified by a reference identifier, such as, for example, a URL that can be shared with users in the group by email, Short Message Service (“SMS”), Quick Response (“QR”) code, Near Field Communication (“NFC”) tags, local group broadcast, or any other channel that may be used to communicate an URL. As described in more detail herein below, the URL directs the users 105a-f to a cross platform web interface that enables them to share, interact and collaborate with web pages seamlessly in real-time from their devices 110a-d.

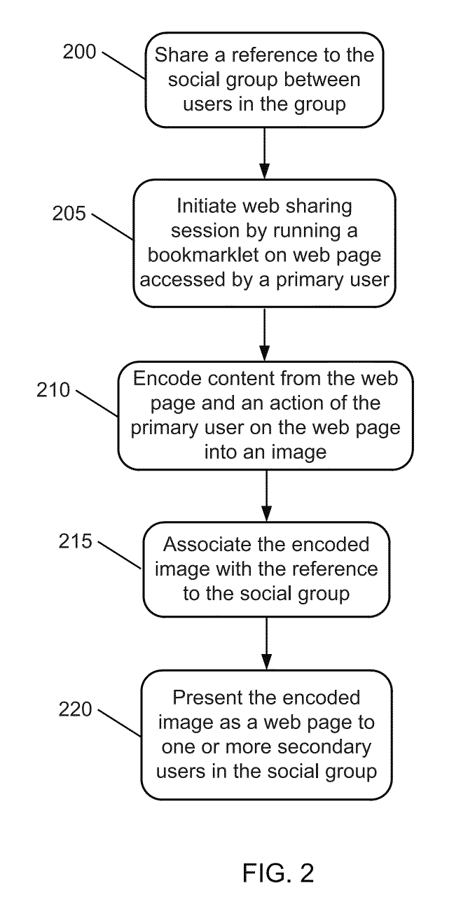

Referring now to FIG. 2, a flowchart for sharing a web browser session between users in a social group is described. First, a primary user creates a social group and shares a reference to the social group with other secondary users in the group (200). The reference may be a URL that can be shared between users in the group by email, SMS, QR code, NFC tag, local group broadcast, or any other channel that may be used to communicate an URL. For example, the URL http://www.example.com/snap/main.html?group-sandbox identifies a group named “sandbox” for users to join. The secondary users may access the group by, for example, receiving the URL from a primary user by email or SMS, automatically discovering the URL through a QR code or NFC tag, receiving a broadcast to their physical location discovered through a geolocation API, or through any other channel that may be used to communicate URLs.

It is appreciated that the URL identifying a social group may be created by anyone by specifying a name or unique identifier. The name or unique identifier may be specified to be hard to guess by others outside of the group (e.g., with a random group name such as t67dg8a or a Globally Unique Identifier “GUID”). The URL can be viewed by any user having access to the URL, either a user of a mobile device collocated with other mobile devices of users in the group or a user of a remote mobile device. It is also appreciated that the URL may be not discoverable by others outside of the social group (i.e., the social group may be a private social group). The URL may be distributed securely and privately among members of the group.

The users enter the URL in a web browser to access a cross-platform web user interface to share, interact and collaborate with web pages viewed in their devices. The primary user accesses a web page that he/she desires to share with the secondary users in the social group. The user runs a bookmarklet on the web page to initiate a web sharing session with the secondary users in the social group (205). In one example, the bookmarklet loads in a Javascript library in the web page to be shared. The bookmarklet has an event listener that detects any user action on the web page (e.g., a change in mouse position, a click of a link, etc.).

When an action is detected, the web page content and the action are encoded into an image to be shared with the secondary users (210). The encoding is performed by rendering the Document Object Model (“DOM”) tree of the web page into a canvas and exporting the canvas as an image (e.g., a base 64 image). The image is then sent to a server along with a mouse position indicating the action performed by the primary user on the web page. At the server, the image and action of the primary user on the web page are converted into multiple image representations, each representation suitable for display at a device of a secondary user in the social group and containing a visual indication of the action of the primary user on the web page. In various examples, the image representations may be PEG or other such format images, with the visual indication representing a mouse position with a visually identifiable icon (e.g., a blue dot on the image to indicate the mouse position). The server then associates the image representations with the reference to the social group (i.e., the URL of the social group) so that the secondary users can be notified by reference of the presence of a new action performed by the primary user on the web page (215). The encoded image is then presented on a web page to the secondary users (220).

It is appreciated that the image encoding enables web pages to be seamlessly shared among the multiple users in the social group without having to re-render the web pages on all users' devices. Since the web page is shared as an image, the web page will look the same and WYSIWYG is maintained on all users' devices regardless of the devices' type, screen resolution and so on. This is not the case when web pages are re-rendered at the devices, as they would look different from device to device. For example, a web page of an online shopping site looks different when viewed at a desktop or a laptop than at a small mobile device (e.g., smart phone). Encoding the web page and an action of the primary user on the web page as an image prevents different versions of the same web page to be viewed by different users. Here, all users in the social group view exactly the same content displayed on their web pages.

It is also appreciated that the server that encodes the image may be a web socket server. The web socket server puts the encoded image into the reference URL corresponding to the social group and the secondary users listen on their designated web socket channels of the presence of the encoded image. The encoded image may be stored in multiple representations, such as multiple resolutions of the same image suitable for different types of user devices.

In various examples, steps 210-220 are repeated any time the primary user performs a different action on the web page shared in the social group. If the primary user changes a mouse position, interacts with the web page by clicking on a link, image, or video to show new content on the web page, the web page is again encoded with the action and presented to the secondary users. This way the secondary users see all the actions performed by the primary user on the web page as well as all the content that is displayed on the web page as a result of the users' actions.

Further, as described in more detail below, the secondary users may also interact with the encoded images that are presented to them and their interactions can be seen by all the other users in the group. That is, the content sharing platform presented herein enables two-way sharing of web pages and actions on the web pages by users in a social group. Any user in the social group can control a web page viewed by another user at any given time.

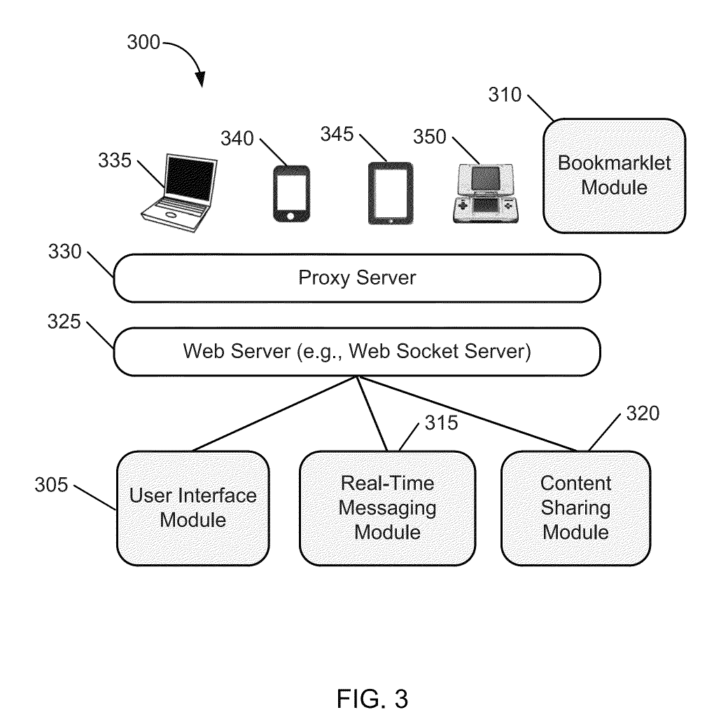

Referring now to FIG. 3, a schematic diagram of a content sharing platform architecture in accordance with various examples is described. Content sharing platform 300 has various modules hosted on one or more servers, including, for example: (1) a User Interface Module 305; (2) a Bookmarklet Module 310; (3) a Real-Time Messaging Module 315; and (4) a Content Sharing Module 320. In various examples, the content sharing platform 300 is hosted on a web server 325 connected to an optional proxy server 330. The proxy server 330 may be a standard web server (e.g., an Apache2 server) with mod_proxy and mod_rewrite modules to ensure that consistent URLs are exposed to users of the content sharing platform 300. The users may access the content sharing platform 300 through a URL request to the proxy server 330 on a number of mobile devices, such as for example, laptop 335, phone 340, tablet 345, and. video game console 350, among others. The URL request directs the users of the content sharing platform 300 to a user interface implemented by the User Interface Module 305.

It is appreciated that the proxy server 330 may be deployed as part of a cloud service and optionally be collocated with the web server 325. It is also appreciated that having proxy server 330 issue consistent URLs enables cookies issued by the various content sharing platform 300 modules to be shared among the modules. The web server 325 may also be a web server (e.g., an Apache 2 server with minimal dependencies on images and external libraries to facilitate replication and load balance. In an example implementation, the web server 325 may use the jQuery library to make Ajax calls and html5 web sockets to make socket calls to the Real-Time Messaging Module 315.

The User Interface Module 305 enables users to share, interact, and collaborate with web pages in a social group. The Bookmarklet Module 310 runs bookmarklets on the web pages to be shared. The bookmarklets track actions of users on the web pages and encode content and actions on the users on the web pages into images. The Real-Time Messaging Module 315 is responsible for handling all events and messages through the Bookmarklet Module 310. The Content Sharing Module 320 associates the encoded images with a reference to the social group and presents the encoded images to users in the social group.

In various examples, the Real-Time Messaging Module 315 may be implemented as a Node.Js server with two types of Application Programming Interfaces (“APIs”): a standard HTTP/Post/Get/Rest API and a WebSocket API through html5 web sockets. The two APIs enable various web clients (e.g., the mobile devices 335-350) to push events and messages through the Real-Time Messaging Module 315 without requiring the full WebSocket stack. The WebSocket API is used to receive notifications and messages in real-time. In one example, the Rest API may also be used for this purpose but with a loss in efficiency.

The Content Sharing Module 320 is responsible for allowing the sharing of web pages using the content sharing platform 300. The Content Sharing Module 320 also sends out notifications through the Real-Time Messaging Module 315 when new encoded images are available to be shared in the social group. The Content Sharing Module 320 may be implemented as a set of Linux scripts using ImageMagick, OpenOffice, Poppler, and Ghostscript.

It is appreciated that the content sharing platform 300 may have additional modules not shown in FIG. 3. For example, the content sharing platform 300 may have various modules to allow the sharing of other content (e.g., documents) with users in the social group.

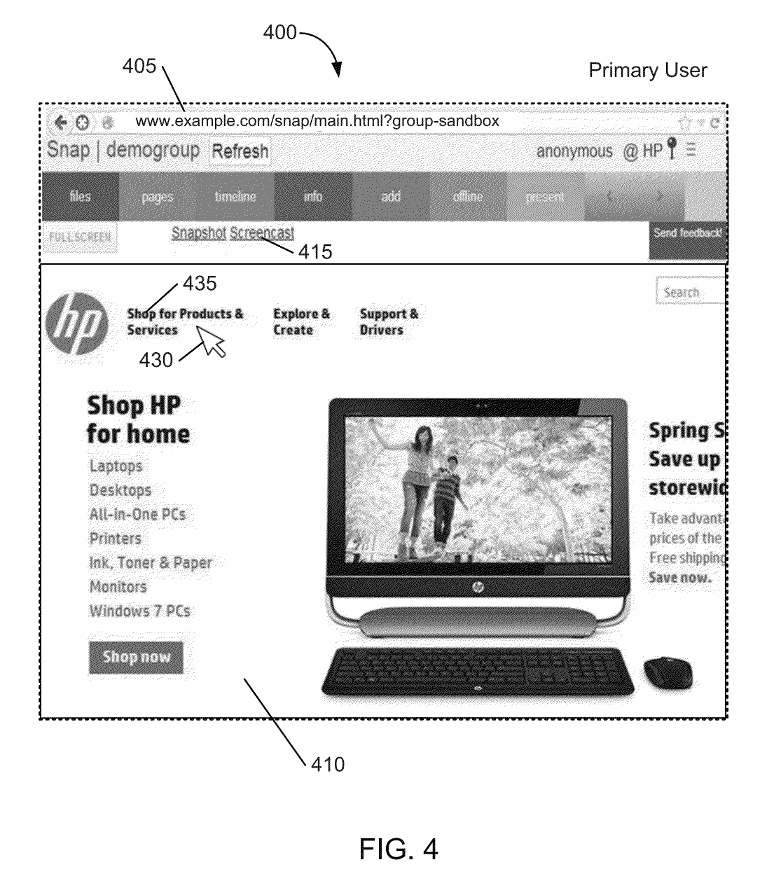

Attention is now directed to FIGS. 4-9, which show the cross-platform web user interface according to various examples. User interface 400 is displayed in a web browser client in a device (e.g., devices 110a-d and 335-350) upon a user entering a URL 405 corresponding to a social group in the web browser client. For example, a primary user may enter the URL 405 in a browser in his/her device to join the group called “sandbox” and initiate a web sharing session with other users in the social group. The primary user may open up an arbitrary web page (e.g., web page 410) in his/her web browser window to share the web page with users in the group. The web page is shared with the social group when the user clicks on the bookmarklet button 415, which may also be displayed in the user's web browser window (not shown)

The user interface 400 is a cross-platform user interface that may be run on any web browser and platform, including, but not limited to, web browsers such as Internet Explorer, Mozilla Firefox, Google Chrome, and Safari, and platforms such as iOS and Android, among others. In addition, the same user interface 400 is run on different types of mobile devices, e.g., desktops, laptops, tablets, mobile phones, and so on. As appreciated by one skilled in the art, there may be some minor customizations done at the web browser client with regards to image resolution, compression, and other features tied to the mobile devices' display.

In various examples, the bookmarklet 415, when clicked by the primary user, tracks all actions performed by the primary user on the web page opened by the user web page 410). The actions may be a change in mouse position relative to the web page 410 and indicated by cursor 430. The bookmarklet 415 detects the position of the cursor 430 and triggers the encoding of the web page 410 and position of the cursor 430 into an image. The image encoding may be performed by rendering the entire DOM tree of the web page 410 into a canvas, converting the canvas into a base64 image and transmitting the base 64 image together with the cursor 430 position to web server 325. The web server 325 then encodes the base64 image and the cursor 430 position into an encoded image that contains a visual indication to the cursor 430 position. The encoded image is then associated with the URL 405 so that all users in the group have access to the content of the web page 410 and the actions performed on the web page 410 by the primary user.

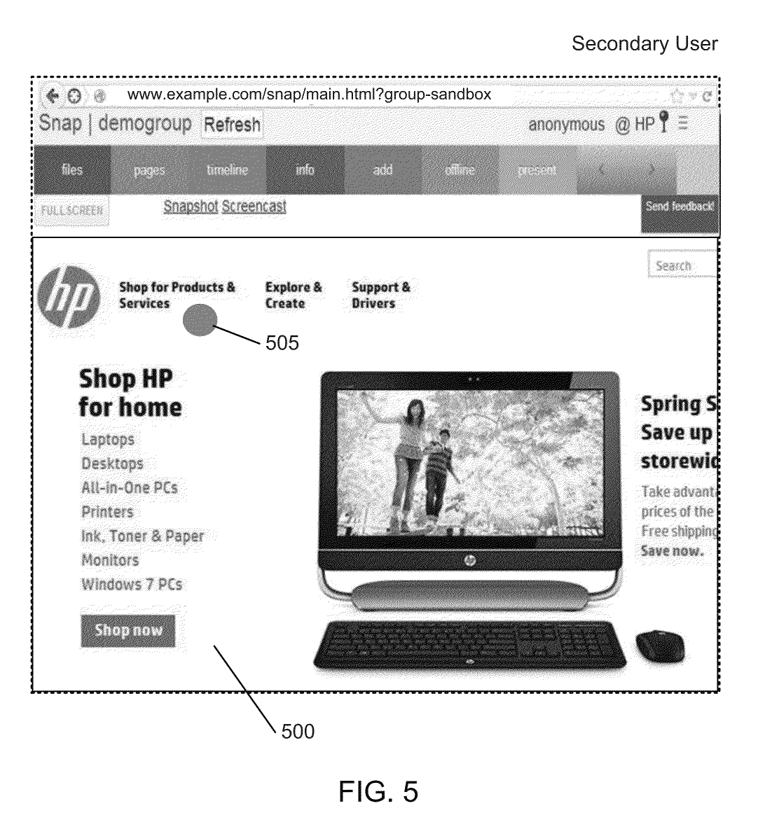

FIG. 5 shows a user interface view of a secondary user in the social group. The secondary user sees the same web page 410 shared by the primary user as a web page 500 with an encoded image. The encoded image shows the same content displayed in web page 410 with a visual indication 505 to represent the action of the primary user on the page 410, e.g., to represent the mouse position of the cursor 430 so that the secondary user can see exactly what the primary user is doing with the web page 410.

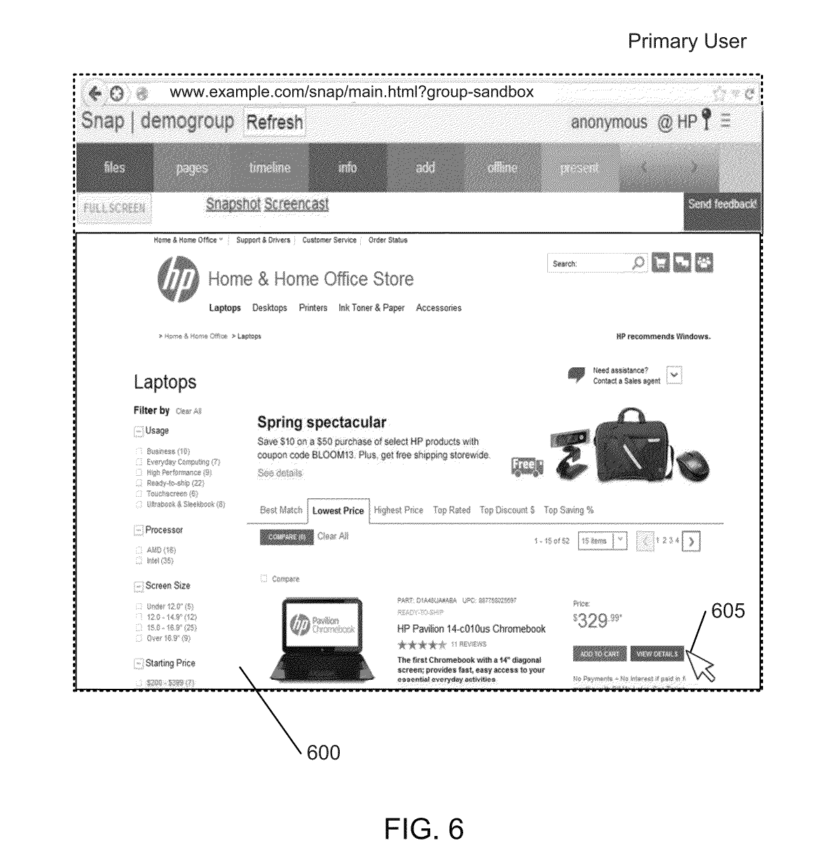

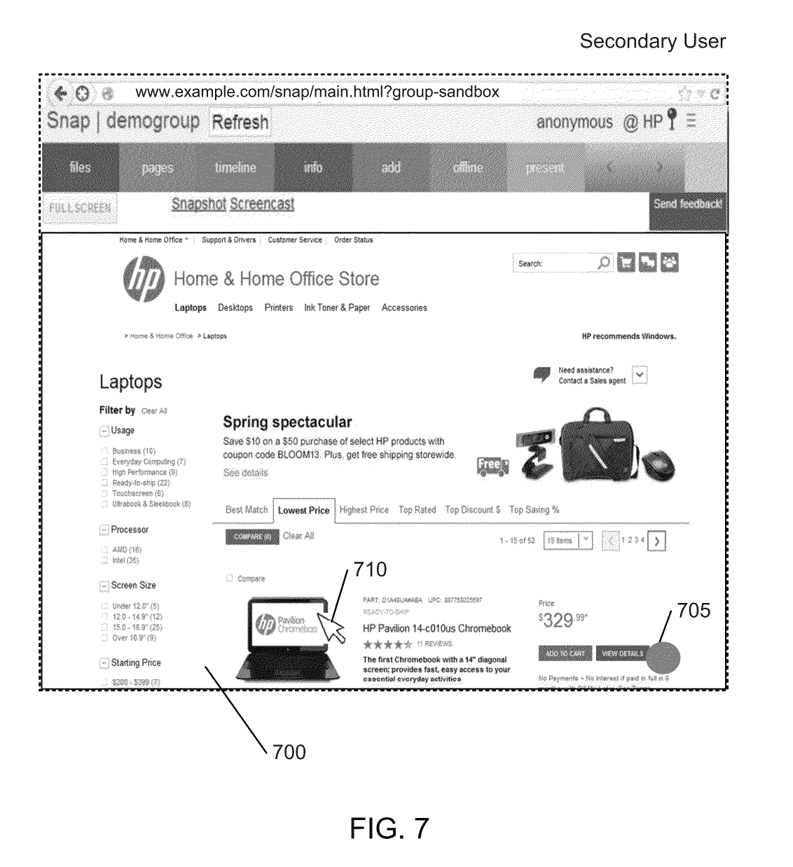

Now suppose the primary user moves the cursor 430 to a different position, say to click on the link 435 and open up a new page 600 as shown in FIG. 6. The bookmarklet 415 detects the action (i.e., the click on the link 435) performed by the primary user and triggers the encoding of the web page 600 and new cursor position 605 into an image. FIG. 7 shows the web page 700 with a visual indication 705 that are displayed to the secondary users in the group. The web page 700 and visual indication 705 respectively represent the content and the cursor position 605 from the web page 600 shared by the primary user. This way all secondary users in the social group view the same content viewed by the primary user, as well as the actions performed by the primary user on the web page 410 (e.g., actions that result in opening of the new page 600).

Any change in action or content in the web pages share by the primary user with the social group are viewed by the secondary users in real-time. The content sharing platform 300 with the user interface 400 therefore enables and facilitates a number of web sharing scenarios, such as, for example, a training scenario where the primary user has to train the secondary users on how to use the various functions on the pages 410 and 600, a publishing scenario where the primary user is showing the secondary users how the content on the web pages 410 and 600 looks like, and so on. One can picture the primary user sharing the web pages 410 and 600 on a laptop in a conference room with various secondary users in the conference room viewing the web page content in their respective laptops, tablets, and smart phones. Since the web pages shared by the primary user are encoded as images, the secondary users view the same content as the primary user on their devices, regardless of their device type, screen size, and so on.

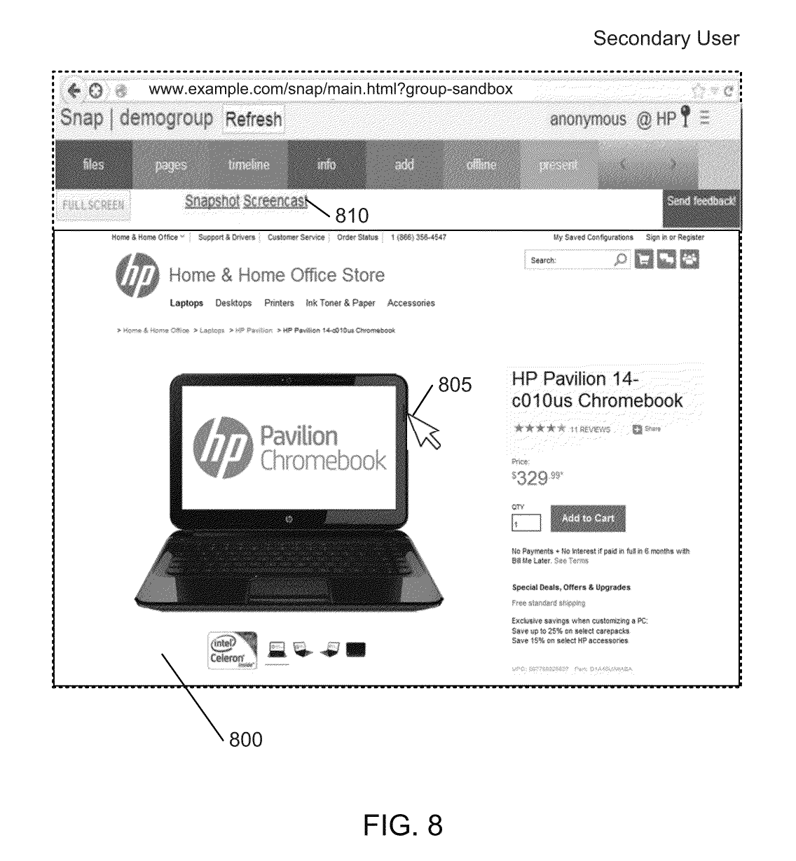

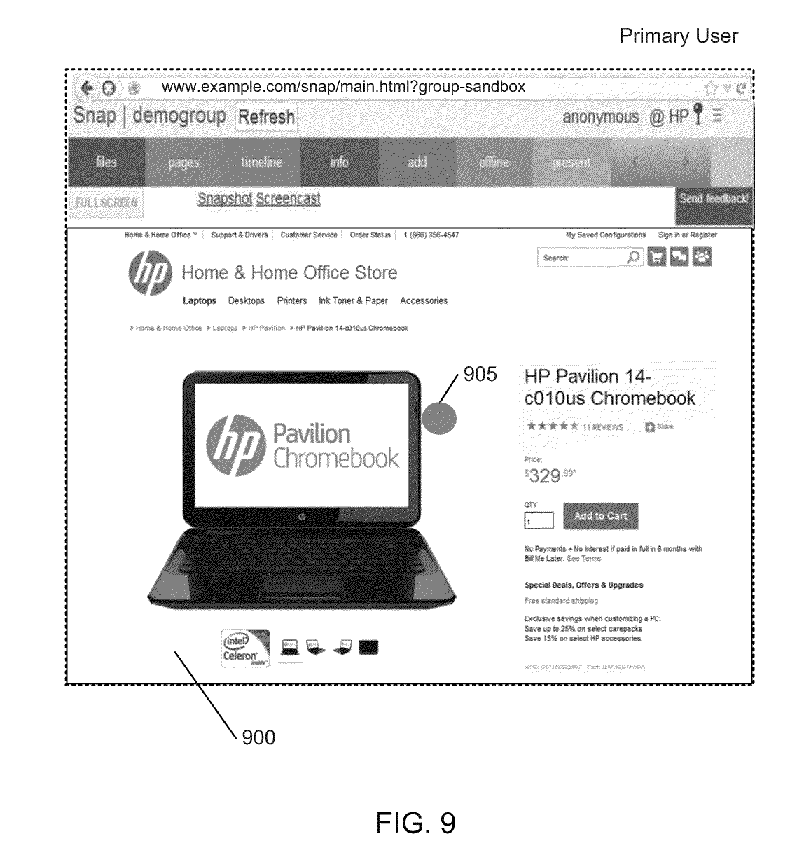

As described above, the sharing of web page content with user interface 400 and bookmarklet 415 can be a two-way sharing, that is, the secondary users can also perform actions on their web pages and the actions can be seen by the primary user and all other secondary users in the group. For example, the secondary user viewing web page 700 wants to show the primary user a more detailed view of the page by clicking on the page as indicated by cursor 710. Doing so will open up the web page 800 for the secondary user, as shown in FIG. 8, and with the bookmarklet 810 running, the web page 800 along with cursor position 805 are encoded into an image with visual indication 905 that is seen as web page 900 in FIG. 9 by the primary user.

It is appreciated that the user interface 400 described above with reference to FIGS. 4-9 is designed to securely share web content in social groups. Groups may not be discoverable but there are various mechanisms to share groups. It is up to the group members how securely they want to share their group. Anyone with access to the group URL has full access to the content being shared, with the exception of web pages that might require some authentication. Hence it is important to not distribute this URL too widely, i.e., on a public crawlable web page if it is desired that the URL remains private. Emailing and SMS-ing the link is safe, but in some situations users may not even want to do that. In such cases, users can encode the URL as a QR code or an NFC tag that only people in the users' physical vicinity have access to. In the conference room scenario described above, the primary user may share a QR code representing the group's URL with all the secondary users in the conference room.

Users are encouraged to select group names that make their identity hard to guess, e.g., GUID-based group ids. All links are redirected to external servers so the URL containing the secret group name does not leak out in the HTTP referrer header. This applies for web page thumbnails, links clickable on inside the web pages, and links popping out of embedded web pages in a separate window. It is also appreciated that for enterprise use cases, these security guarantees may not be strong enough. In these cases, the content sharing platform described herein can be deployed in an enterprise intranet.

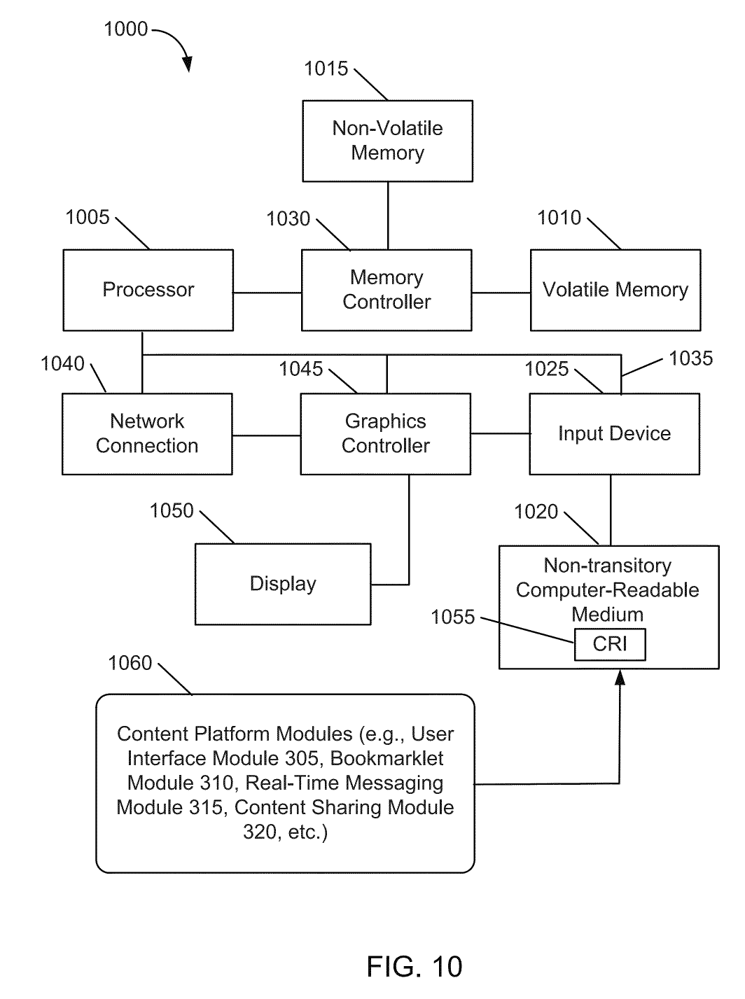

As described above, the modules used in the content sharing platform 300 in FIG. 3 may be hosted in a web server 325. Referring now to FIG. 10, a block diagram of an example computing system for hosting the modules of FIG. 3 according to various examples of the present disclosure is described. The computing system 1000 (e.g., a web socket server) can include a processor 1005 and memory resources, such as, for example, the volatile memory 1010 and/or the non-volatile memory 1015, for executing instructions stored in a tangible non-transitory medium (e.g., volatile memory 1010, non-volatile memory 1015, and/or computer readable medium 1020) and/or an application specific integrated circuit (“ASIC”) including logic configured to perform various examples of the present disclosure.

A machine (e.g., a computing device) can include and/or receive a tangible non-transitory computer-readable medium 1020 storing a set of computer-readable instructions (e.g., software) via an input device 1025. As used herein, the processor 1005 can include one or a plurality of processors such as in a parallel processing system. The memory can include memory addressable by the processor 1005 for execution of computer readable instructions. The non-transitory computer readable medium 1020 can include volatile and/or non-volatile memory such as a random access memory (“RAM”), magnetic memory such as a hard disk, floppy disk, and/or tape memory, a solid state drive (“SSD”), flash memory, phase change memory, and so on. In some examples, the non-volatile memory 1015 can be a local or remote database including a plurality of physical non-volatile memory devices.

The processor 1005 can control the overall operation of the computing system 1000. The processor 1005 can be connected to a memory controller 1030, which can read and/or write data from and/or to volatile memory 1010 (e.g., RAM). The memory controller 1030 can include an ASIC and/or a processor with its own memory resources volatile and/or non-volatile memory). The volatile memory 1010 can include one or a plurality of memory modules (e.g., chips). The processor 1005 can be connected to a bus 1035 to provide communication between the processor 1005, the network connection 1040, and other portions of the computing system 1000. The non-volatile memory 1015 can provide persistent data storage for the computing system 1000. Further, the graphics controller 1045 can connect to a display 1050.

Each computing system 1000 can execute computer-readable instructions that are stored on a non-transitory computer-readable medium 1020. The non-transitory computer-readable medium 1020 can be integral, or communicatively coupled, to computing device 1000, in either a wired or wireless manner. For example, the non-transitory computer-readable medium 1020 can be an internal memory, a portable memory, a portable disk, or a memory located internal to another computing resource (e.g., enabling the computer-readable instructions to be downloaded over the Internet).

The non-transitory computer-readable medium 1020 can have computer-readable instructions 1055 stored thereon that are executed by the processor 1005 to implement the modules of content sharing platform 300 (e.g., User Interface Module 300, Bookmarklet 310, Real-Time Messaging Module 315, Content Sharing Module 320, etc.) according to the present disclosure. The non-transitory computer-readable medium 1020, as used herein, can include volatile and/or non-volatile memory. Volatile memory can include memory that depends upon power to store information, such as various types of dynamic random access memory (“DRAM”), among others. Non-volatile memory can include memory that does not depend upon power to store information. Examples of non-volatile memory can include solid state media such as flash memory, EEPROM, and phase change random access memory (“PCRAM”), among others. The non-transitory computer-readable medium 1020 can include optical discs, digital video discs (“DVD”), Blu-Ray Discs, compact discs (“CD”), laser discs, and magnetic media such as tape drives, floppy discs, and hard drives, solid state media such as flash memory, EEPROM, PCRAM, as well as any other type of computer-readable media.

Advantageously, the methods and modules of the content sharing platform 300 presented herein enable users to share web pages in real-time within social groups. The content sharing platform 300 is compatible with many types of mobile devices (e.g., laptops, mobile phones, tablets, etc.), operating systems (e.g., iOS, Android, etc.), web browsers (e.g., Internet Explorer, Mozilla Firefox, Safari, Google Chrome, etc.), and screen sizes (e.g., small to large). Users may instantly access the content sharing platform 300 without requiring any prior configuration. The content sharing platform 300 provides an interactive and collaborative two-way web sharing experience, all with instant access and set-up.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein. For example, it is appreciated that the present disclosure is not limited, to a particular computing system configuration, such as computing system 1800.

What is claimed is:

1. A computer-implemented method for sharing a web browser session between users in a social group, comprising:
sharing a reference to the social group between users in the social group;
initiating a web sharing session by running a bookmarklet on a web page accessed by a primary user in the social group;
encoding content from the web page and an action of the primary user on the web page into an image;
associating the encoded image with the reference to the social group; and
presenting the encoded image on a web page to one or more secondary users in social group.

2. The computer-implemented method of claim 1, wherein the primary user and the one or more secondary users in the social group see the same web page on their devices rendered as the image.

3. The computer-implemented method of claim 1, further comprising emulating on the web page accessed by the primary user an action of a secondary user performed on the image presented to the secondary user.

4. The computer-implemented method of claim 1, wherein sharing a reference to the social group comprises sharing a URL, QR code, or NFC tag information with users in the social group.

5. The computer-implemented method of claim 1, wherein initiating a web sharing session by running a bookmarklet on a web page accessed by a primary user in the social group comprises running an event listener to track actions of the primary user on the web page.

6. The computer-implemented method of claim 1, wherein encoding content from the web page into an image comprises rendering a Document Object Model (“DOM”) tree into a canvas and converting the canvas to a first representation of the image.

7. The computer-implemented method of claim 6, further comprising converting the first representation of the image and action of the primary user on the web page into multiple other representations of the image, each representation suitable for display at a device of a secondary user in the social group and containing a visual indication of the action of the primary user on the web page.

8. The computer-implemented method of claim 1, comprising repeating the encoding and associating steps when the content of the web page is changed or the primary user performs another action on the web page.

9. The computer-implemented method of claim 3, comprising repeating the performing an action step when the secondary user performs another action on the image presented to the secondary user.

10. A system for sharing a web browser session between users in a social group, comprising:
a web user interface module to enable users to share, interact, and collaborate with web pages in a social group;
a bookmarklet module to track actions of a primary user on a web page and encode content from the web page and the actions of the primary user into images;
a real-time messaging module to process events and messages from the bookmarklet module; and
a content sharing module to associate the encoded images with a reference to the social group and present the encoded images to one or more secondary users in the social group.

11. The system of claim 10, wherein the bookmarklet module is accessed by the one or more secondary users to track the actions of the one or more secondary users on the images presented to the one or more secondary users.

12. The system of claim 11, wherein the bookmarklet module triggers an action to be performed on the web page accessed by the primary user by emulating on the web page accessed by the primary user an action of a secondary user performed on an image presented to the secondary user.

13. The system of claim 10, wherein the action of the primary user on the web page presented to one or more secondary users in the social group comprises a mouse position.

14. A non-transitory computer-readable medium comprising executable instructions to:
form a social group of users, the social group identified by a reference shared between the users in the social group;
initiate a web sharing session by running a bookmarklet on a web page accessed by a primary user in the social group;
share an encoded image of the web page accessed by the primary user and an action of the primary user on the web page with one or more secondary users in the social group; and
emulate an action of a secondary user on the web page accessed by the primary user.

15. The non-transitory computer-readable medium of claim 14, wherein to share an encoded image of the web page with one or more secondary users comprises to share multiple representations of the image suitable for display at a device of a secondary user in the social group, each representation suitable for display at a device of a secondary user in the social group and containing a visual indication of the action of the primary user on the web page.
